(19) United States
(12) Patent Application Publication
(10) Pub. No.: US 2007/0140658 A1
(43) Pub. Date: Jun. 21, 2007

(54) Time-shifting user interface method with automatic chaptering and audio-visual device using the method

(75) Inventor: Sang-jun Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/599,301

(22) Filed: Nov. 15, 2006

(30) Foreign Application Priority Data
Dec. 21, 2005 (KR) 10-2005-0126943

(51) Int. Cl. H04N 7/00

(52) U.S. Cl. 386/95

(57) ABSTRACT

A time-shifting user interface method employing an automatic chaptering function includes analyzing stored AV data and dividing the stored AV data into one or more chapters, and displaying a time-shifting user interface including information related to the one or more chapters on a screen. An audio-visual (AV) device uses the method.

### CROSS-REFERENCE TO RELATED PATENT APPLICATION

This application claims priority from Korean Patent Application No. 10-2005-0126943, filed on Dec. 21, 2005, in the Korean Intellectual Property Office, the disclosure of which is incorporated herein in its entirety by reference.

### BACKGROUND OF THE INVENTION

1. Field of the Invention

The present invention relates to time-shifting of audio-visual (AV) devices such as personal video recorders (PVR), and more particularly, to a user interface for time-shifting and the AV device using the method.

2. Description of the Related Art

A personal video recorder (PVR) is a new digital recorder which records broadcasting information in a hard disk or a memory chip and reproduces the information, unlike a video cassette recorder (VCR) which records picture signals in a magnetic tape. The PVR is similar to a conventional VCR in that it stores and reproduces programs from a broadcasting station, but the PVR is different from the VCR in that the PVR records the program from the broadcasting station in a hard disk and reproduces the programs in the same manner as reproducing files in a computer. In addition, the PVR includes a central processing unit (CPU), a memory chip storing operation systems and reproduction software, and a hard disk with large capacity for storing broadcasting contents.

When a channel is selected in the PVR, a current broadcasting signal is automatically stored in the hard disk as digital data and displayed on the screen at the same time. When a stop button is pushed and then a play button is pushed, the stored broadcasting signal is reproduced from the stopped point. In addition, a user can reproduce the current broadcasting program, reproduce the program slowly, or skip a part of the program to find and watch a desired part of the program. The aforementioned function is referred to as “time-shifting”.

The time-shifting function is widely used in AV devices such as digital versatile disc (DVD) players, as well as the PVR, while the conventional time-shifting user interface provides only a time searching function.

FIG. 1 shows a time-shifting user interface used for the conventional PVR. Referring to FIG. 1, the time-shifting user interface 110 having a shape of a bar is positioned at the bottom of the screen where a motion picture is displayed. On this time-shifting user interface 110, time of day 40, broadcasting time 20 of the motion picture currently displayed on the screen, recording time 10, and a current reproduction mode are displayed. According to the example shown in FIG. 1, the time of day 40 is 11:30, the broadcasting program is recorded at 10:30, and the user watches the broadcasted motion picture broadcasted at 11:19. The aforementioned user interface searches the stored motion picture with respect to time or frames.

FIGS. 2A and 2B are diagrams illustrating a search operation in the conventional time-shifting user interface, wherein the time-shifting user interface is based on time. FIG. 2A shows a state 210 that a user watches a broadcast program at 11:42. FIG. 2B shows a state 220 that when the user inputs a backward search command by the use of an input unit, a reproduction point is moved backward by one minute from the previous reproduction time. If a time-shifting user interface is based on frames, forward/backward search is possible with respect to a predetermined number of frames.

However, the aforementioned conventional time-shifting user interface provides only a time search or frame search function, so the user must perform complicated operations to move the reproduction point to the desired scene. Further, the user must remember the number of minutes or the number of frames in the past where the desired data is reproduced while watching the AV data, and move the reproduction point to the desired point to reproduce the desired data.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a time-shifting user interface method in which a reproduction point can be moved to a desired scene with simple operations, and an audio-visual (AV) device using the method.

According to an aspect of the present invention, there is provided a time-shifting user interface method. The method includes: analyzing stored AV data and dividing the stored AV data into one or more chapters; and displaying a time-shifting user interface including information on the one or more chapters on a screen.

The time-shifting user interface method may further include: receiving a chapter search command from a user; moving a reproduction point of the stored AV data in a unit of a chapter in response to a chapter search command; and displaying the moved reproduction point on the time-shifting user interface.

The displaying a time-shifting user interface may include displaying a representative image of each chapter in the form of a thumbnail on the time-shifting user interface.

The dividing the stored AV data may include: receiving a command for setting the number of chapters from the user; and dividing the stored AV data into chapters corresponding to the command for setting the number of chapters.

According to another aspect of the present invention, there is provided an AV device having a function of reproducing AV data and a time-shifting function. The AV device includes: a storage unit which stores the AV data; a display unit displaying a time-shifting user interface and reproducing the AV data; and a control unit which displays the AV data stored in the storage unit, divides the AV data into one or more chapters, and instructs the display unit to display chapter information on the time-shifting user interface.

The AV device may further include an input unit which receives a command from a user. The control unit may move a reproduction point in a unit of a chapter in response to a chapter search command when the chapter search command is received through the input unit and may instruct the display unit to display the moved reproduction point on the time-shifting user interface.

The control unit may divide the AV data into chapters corresponding to the command for setting the number of chapters when the command for setting the number of chapters is received through the input unit.

### BRIEF DESCRIPTION OF THE DRAWINGS

The above and other aspects of the present invention will become more apparent by describing in detail exemplary embodiments thereof with reference to the attached drawings in which:

FIG. 1 illustrates a conventional time-shifting user interface;

FIGS. 2A and 2B are diagrams illustrating a search operation in the conventional time-shifting user interface;

FIG. 3 illustrates a time-shifting user interface according to an exemplary embodiment of the present invention;

FIG. 4 is a flow chart illustrating a method of the time-shifting user interface according to an exemplary embodiment of the present invention;

FIGS. 5A to 5C are diagrams illustrating the search operation on the time-shifting user interface according to an exemplary embodiment of the present invention;

FIGS. 6A to 6C are diagrams illustrating controlling a time interval of a chapter setting on the time-shifting user interface according to an exemplary embodiment of the present invention; and

FIG. 7 is a block diagram illustrating a structure of an audio-visual device using the time-shifting user interface.

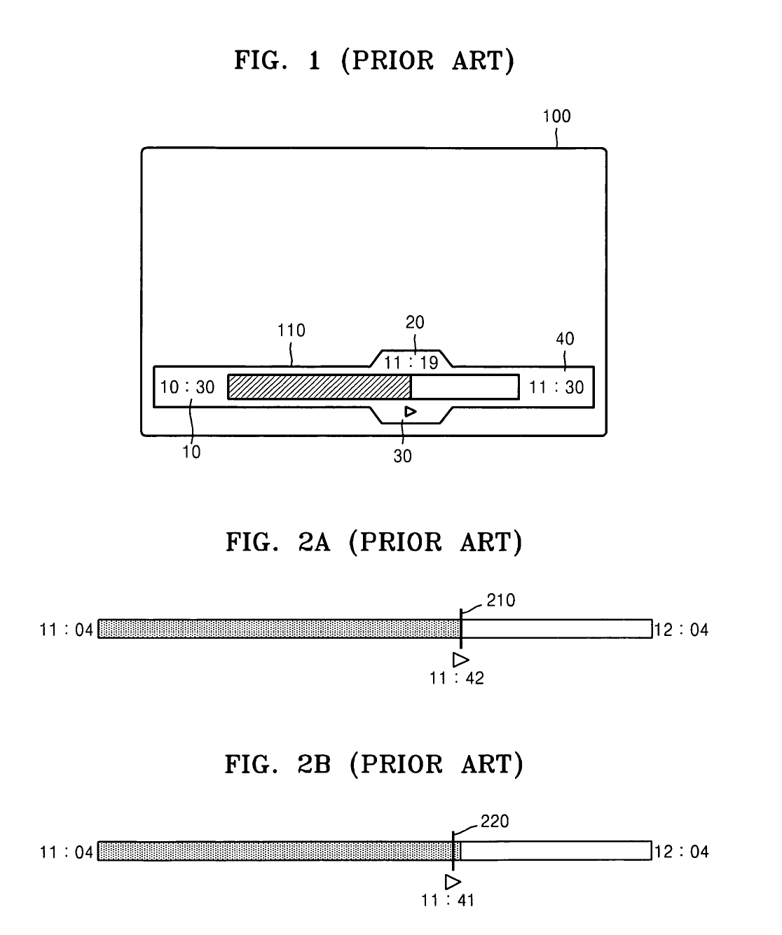

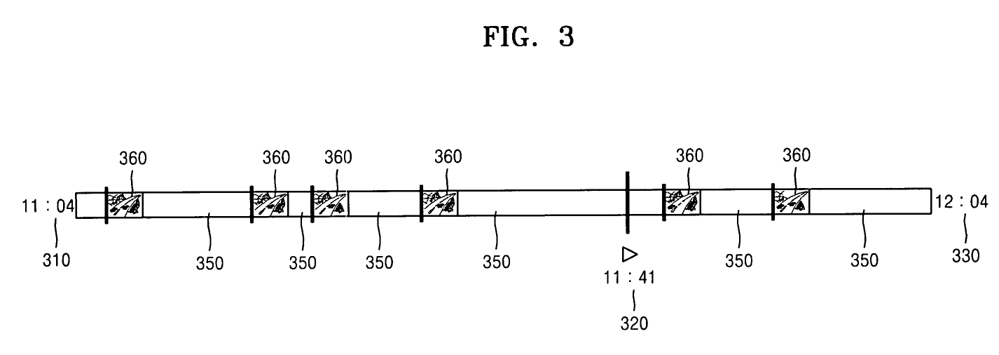

### DETAILED DESCRIPTION OF THE EXEMPLARY EMBODIMENTS

The present invention divides AV data into one or more sections, which may be different in length from each other, and provides a user with information on the one or more sections. The section can be a chapter or another type of unit for dividing AV data. An exemplary embodiment according to the present invention will be described in detail with reference to the accompanying drawings.

FIG. 3 illustrates a time-shifting user interface according to an exemplary embodiment of the present invention. The time-shifting user interface illustrated in FIG. 3 has a shape of a play bar and can be applied to a personal video recorder (PVR) system. Referring to FIG. 3, on the time-shifting user interface, information on first recording time 310 of recorded broadcasting data, broadcasting time 320 of broadcasting data currently displayed on the screen, and time of day 330 are displayed. The broadcasting data is divided into chapters 350 and displayed. For AV data, a chapter is a unit including one or more scenes. In the example illustrated in FIG. 3, the broadcasting data divided into 6 chapters from 11:04 to the current time 12:04 is stored. In addition, the information on each chapter is displayed as a small image in the form of a thumbnail.

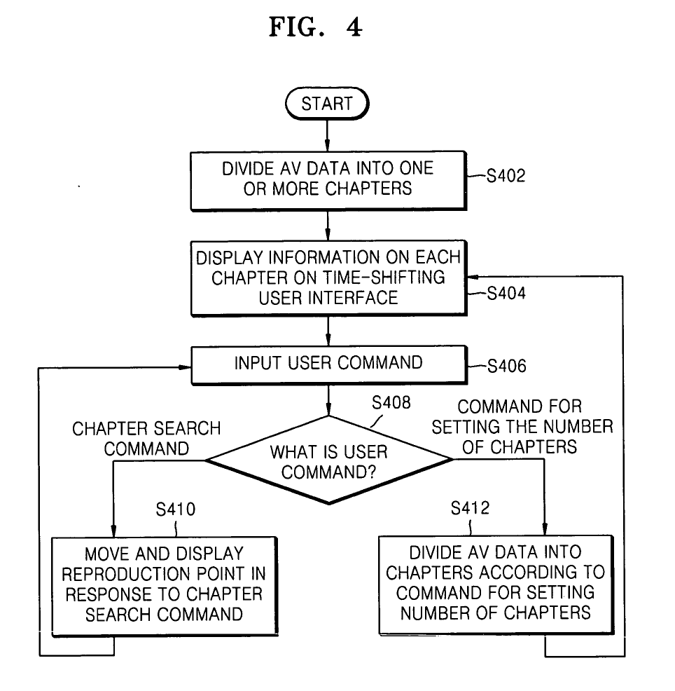

FIG. 4 is a flow chart illustrating a method for the time-shifting user interface according to an exemplary embodiment of the present invention.

AV data stored in an AV device is divided into one or more chapters (S402), defined hereinafter as “chaptering.” Chaptering can be performed by analyzing the stored AV data. For example, chaptering can be performed at a point in which color or brightness of video is changed rapidly. In the case of broadcasting data, information on the broadcasting data is recorded in Electronic Program Guide and the EPG is transmitted with broadcasting stream. The information on each scene is stored at the same time the broadcasting data is recorded, so the chaptering can be performed scene by scene by using the information. Alternatively, the chaptering can be performed at a point in which a broadcasting program is changed into another program. The chaptering is performed as a background process while recording and reproducing the AV data. The information on each chapter is displayed on the time-shifting user interface (S404). As described above, for AV data, one scene of each chapter can be displayed as a thumbnail.

When a user command is input through input unit (S406), the time-shifting user interface operates according to the input command (S408). If the chapter search command is input, the reproduction point of the stored AV data is moved in a unit of a chapter according to the input chapter search command, and the moved reproduction point is displayed on the time-shifting user interface (S410). If a command for setting the number of chapters is input, the stored AV data is divided into chapters according to the input command (S412). The chaptering result is displayed on the time-shifting user interface (S404).

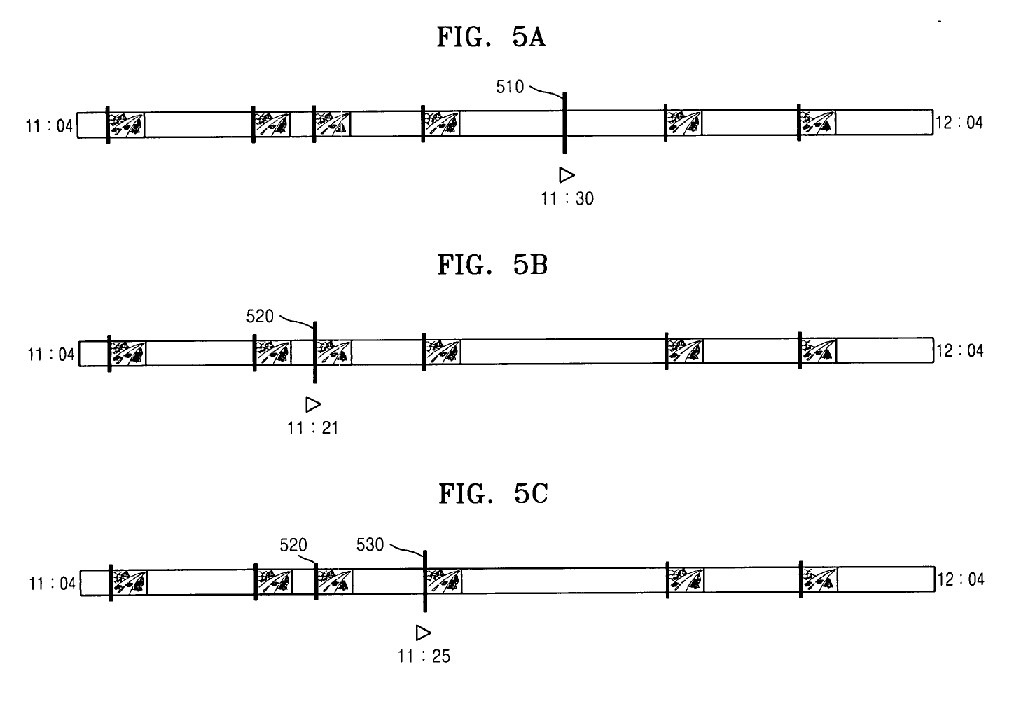

FIGS. 5A to 5C are diagrams illustrating the search operation on the time-shifting user interface according to an exemplary embodiment of the present invention. Referring to FIG. 5A, the AV data 510 at 11:30 is reproduced. Referring to FIG. 5B, when the user input a previous chapter search command, the reproduction point is moved to the start point 520 of the previous chapter and the previous chapter is reproduced. Referring to FIG. 5C, when the user inputs a next chapter search command, the reproduction point is moved to the start point 530 of the next chapter and the next chapter is reproduced.

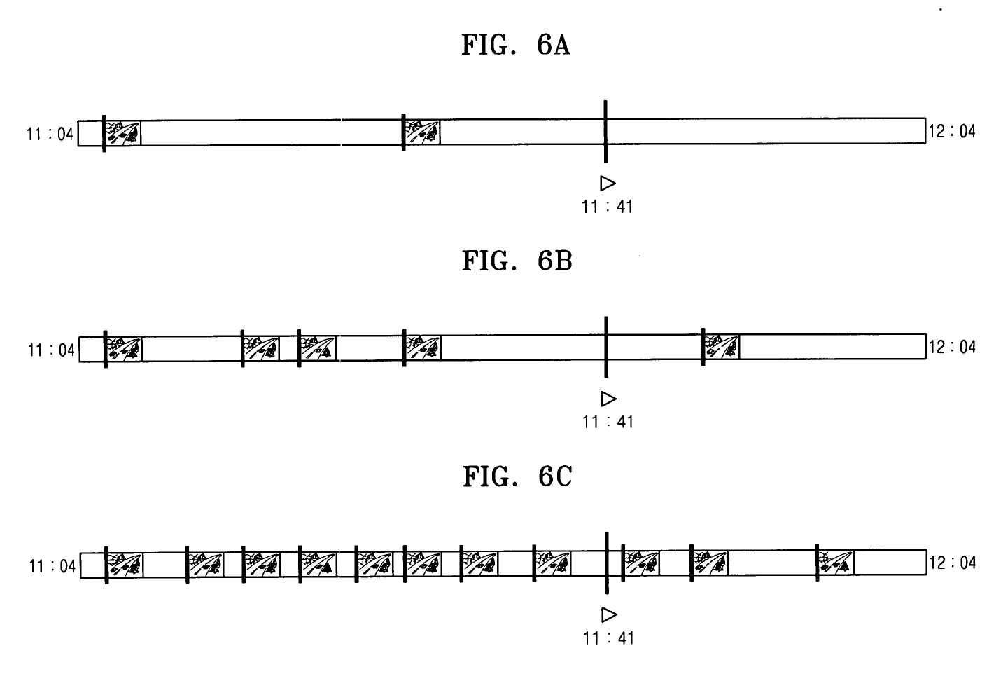

FIGS. 6A to 6C are diagrams illustrating controlling a chapter interval on the time-shifting user interface according to an exemplary embodiment of the present invention. The user can control the number of chapters. If the number of chapters is set to a high number, the AV data is divided into smaller chapters and the user searches the AV data in detail. If the number of chapters is set to a low number, the AV data is divided into larger chapters and the user searches the AV data faster. For example, referring to FIG. 6A, if the number of chapters is set to a low number, then the AV data is divided into 2 chapters, in FIG. 6B, if the number of chapters is set to an intermediate number, then the AV data is divided into 5 chapters, and in FIG. 6C, if the number of chapters is set to a high number, then the AV data is divided into 11 chapters. The number of chapters may be set to a predetermined value in an AV device, or may be changed during the operation of the AV device by the user.

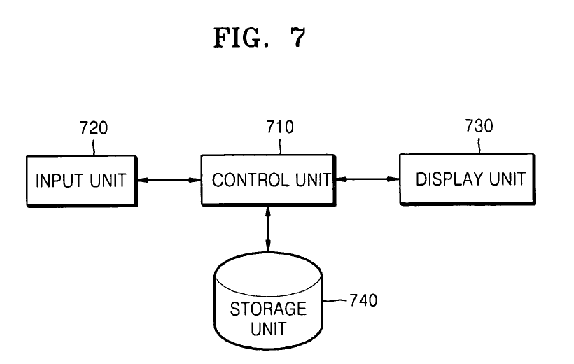

FIG. 7 is a block diagram illustrating a structure of an audio-visual device using the time-shifting user interface.

Referring to FIG. 7, the AV device for reproducing the AV data with time-shifting includes: an input unit 720 which receives a user command; a storage unit 740 which stores the AV data; a display unit 730 which displays a time-shifting user interface and reproduces the AV data; and a control unit 710 which reproduces the AV data stored in the storage unit 740, displays the reproduced AV data on the display unit 730, analyzes the AV data, divides the AV data into one or more chapters, and instructs the display unit 730 to display chapter information on the time-shifting user interface. In addition, the control unit 710 changes the chapter interval and controls the chapter search for the AV data according to a received user command through the input unit 720.

The invention can also be embodied as computer readable codes stored on a computer readable recording medium.

As described above, according to the exemplary embodiments of the present invention, the AV data can be searched in a unit of a chapter while reproducing the AV data, so the user can conveniently use the time-shifting function. In addition, the user can control the number of chapters, so the user can move the reproduction point to the desired scene with a small number of operations.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A time-shifting user interface method, the method comprising:
analyzing stored audio-visual (AV) data;
dividing the stored AV data into one or more sections; and
displaying a time-shifting user interface which displays information including information on the one or more sections on a screen.

2. The method of claim 1, further comprising:
receiving a section search command from a user;
moving a reproduction point of the stored AV data in a unit of a section in response to the section search command; and
displaying the moved reproduction point on the time-shifting user interface.

3. The method of claim 2, wherein the displaying a time-shifting user interface comprises displaying a representative image of each section in the form of a thumbnail on the time-shifting user interface.

4. The method of claim 3, wherein the dividing the stored AV data comprises:
receiving a command for setting the number of section; and
dividing the stored AV data into sections corresponding to the command for setting the number of sections.

5. An audio-visual (AV) device having a function of reproducing AV data and a time-shifting function, the AV device comprising:
a storage unit which stores the AV data;
a display unit which displays a time-shifting user interface and reproduces the AV data; and
a control unit which analyzes the AV data stored in the storage unit, divides the AV data into one or more sections, and instructs the display unit to display section information on the time-shifting user interface.

6. The AV device of claim 5, further comprising an input unit which receives a command, wherein the control unit moves a reproduction point in a unit of a section in response to a section search command when the section search command is received through the input unit and instructs the display unit to display the moved reproduction point on the time-shifting user interface.

7. The AV device of claim 6, wherein the section information displayed on the time-shifting user interface is in the form of a thumbnail displaying a representative image of each section.

8. The AV device of claim 7, wherein the control unit divides the AV data into sections corresponding to a command for setting the number of sections when the command for setting the number of sections is received through the input unit.

9. A computer program embodied in a computer-readable medium, comprising instructions to make a computer perform a time-shifting user interface method, the program comprising:
analyzing stored audio-visual (AV) data;
dividing the stored AV data into one or more sections; and
displaying a time-shifting user interface which displays information including information on the one or more sections on a screen.

10. The program of claim 9, further comprising:
receiving a section search command from a user;
moving a reproduction point of the stored AV data in a unit of a section in response to the section search command; and
displaying the moved reproduction point on the time-shifting user interface.

11. The program of claim 10, wherein the displaying a time-shifting user interface comprises displaying a representative image of each section in the form of a thumbnail on the time-shifting user interface.

12. The program of claim 11, wherein the dividing the stored AV data comprises:
receiving a command for setting the number of sections; and
dividing the stored AV data into sections corresponding to the command for setting the number of sections.
